(19) United States
(12) Patent Application Publication
(10) Pub. No.: US 2005/0010814 A1
(43) Pub. Date: Jan. 13, 2005

(54) System and method for preventing and delaying the distribution of electronic mail virus

(76) Inventors: Sung-Yeop Lim, Seoul (KR); Woo-joo Lee, Seoul (KR)

Correspondence Address: Thomas M Galgano;Galgano & Burke, 300 Rabro Drive, Suite 135, Hauppauge, NY, 11788, US

(21) Appl. No.: 10/491,694

(22) PCT Filed: Oct. 1, 2002
(86) PCT No.: PCT/KR02/01840

(30) Foreign Application Priority Data
Oct. 6, 2001 (KR) 2001/61650

(51) Int. Cl. H04L 9/00

(52) U.S. Cl. 713/201

(57) ABSTRACT

System for preventing and delaying distribution of computer viruses through electronic mails, includes a virus checking module and a curing inducement module for inducing a virus transmitting client. In system and method of this invention, an IP address of the virus transmitting client is stored as an infected IP address and a predetermined blocking time is imposed to the infected IP address. Until the blocking time has passed, normal messages having no virus from the infected IP address are not allowed to be processed.

### TECHNICAL FIELD

The present invention relates to prevention of the distribution and delaying the circulation of viruses through an electronic mail, and more particularly to a system and a method for preventing and delaying the distribution of electronic mail viruses by transmitting messages for curing inducement to the clients and imposing a blocking time for the client's IP address.

### BACKGROUND ART

Computer virus is “the combination of codes (instructions) run on a computer, which transforms a program (execution file) or executable part (boot record, operating system and so on) and replicates into the transformed program itself or its modification”. The computer virus takes effect broadly from simply displaying a message in a screen to destroying a program or data. On the other hand, worms are more destructive programs which duplicate themselves throughout disk and memory using up all available computer resources. By reason of the destructive nature, a need exists for removing viruses and worms from users' computers and networks.

Viruses and worms, made on the purpose of their proliferation, can be spread most widely through electronic mail communications than any other communications. Therefore, many virus makers are interested in spreading viruses through an electronic mail network. Especially, lots of makers those who are concerned about the production of macro virus added a function for an electronic mail in their viruses and worms. Currently, Windows users widely use Outlook and Outlook Express for their mail client programs. These programs support MAPI (Message Application Programming Interface) as mail relevant function and provide the function which can transmit easily an electronic mail in various programs including general application, MS Office, VB script and so on. Accordingly, virus makers target these programs in spreading viruses because most users use the programs and also viruses are easily transmitted in the programs.

In electronic mail systems infective and destructive viruses can bring about serious problems, because all the users may be potential virus distributors, and the spread of viruses is significantly rapid and wide ranged when compared with any other communication network. However, users may connect their computers to network without knowing the infection of their computers and it is impossible to expect that all users execute virus detection or protection programs prior to the accessing electronic mail systems. Accordingly, there is a need for intervention of electronic mail service providers or network managers.

In general, a network manager adds a virus filtering function to his system to prevent computer viruses from penetrating or circulating in users' electronic mails. The filtering function includes detecting if computer viruses or worms are contained in data from a client, prevention of transfer of the infected data and informing the virus infection to the client.

However, considering the scale, rapid-access and infectiousness of viruses through an electronic mail, a need exists for electronic mail service producers' more active intervention for preventing the distribution of viruses.

### DISCLOSURE OF THE INVENTION

Accordingly, an object of the present invention is to effectively prevent and delay the distribution of virus through an electronic mail communication system.

Another object of the present invention is to induce more actively the infected users to cure viruses in an electronic mail communication system.

In order to accomplish the above purposes, the present invention provides a system for preventing and delaying the distribution of electronic mail viruses, which connected with the plurality of transmitting clients and receiving clients comprising:
a virus checking module for determining whether viruses are contained in the electronic mail received from the transmitting clients;
an account manager for storing the account of client infected with virus; and
a curing inducement module for informing the infected clients of infection and inducing the clients to cure the viruses,
   wherein the infected transmitting clients' IP address is stored as the infected IP address and a predetermined blocking time is imposed to the infected IP address, and
   a process of normal messages transferred from the infected IP address is denied until the blocking time has passed.

In order to accomplish the above object, the present invention provides a method for preventing and delaying the distribution of electronic mail viruses, the method comprising the steps of:
receiving electronic mail messages from users;
determining whether the received electronic mail messages are infected with viruses;
dividing the received electronic mail messages into infected messages and normal messages based on the determination result; and
disallowing a process of only infected messages of the received electronic mail messages, storing the users' IP address to the infected 1P address, and transmitting messages for curing inducement to the infected users; and
imposing a predetermined blocking time for the infected IP address,
wherein the determining step includes determining whether electronic mail messages are transmitted from the infected IP address in the predetermined blocking time, and denying the normal messages to be processed until the desired blocking time has passed, even when the electronic mail messages transmitted from the infected IP address are normal messages.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a blocking view showing a electronic mail system in which a method for preventing and delaying the distribution of electronic mail virus according to the present invention is acceptable; and

FIG. 2 is a flowchart showing a method for preventing and delaying the distribution of electronic mail virus according to the present invention.

### BEST MODE FOR CARRYING OUT THE INVENTION

This invention will be described in further detail by way of example with reference to the accompanying drawings.

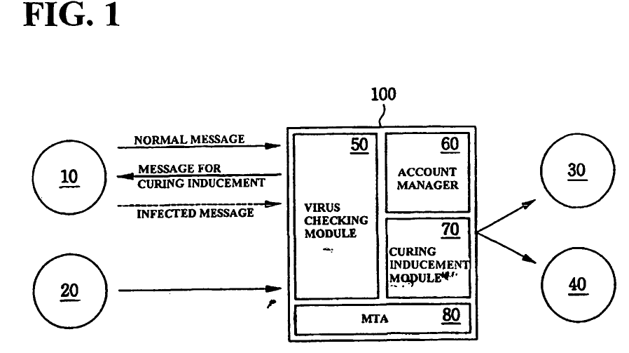

FIG. 1 is a blocking view showing a electronic mail system in which a method for preventing and delaying the distribution of electronic mail virus according to the present invention is acceptable.

As shown in FIG. 1, a mail server system 100 is a kind of a electronic mail communication system, which is connected with a plurality of transmitting clients 10 and 20 and receiving clients 30 and 40. The client includes workstation, personal computer, labtop, palmtop and network computer. The client is connected with the mail sever system 100 through a public network such as Internet or LAN (Local Area Network), and communicates with the mail sever system 100 by SMTP (Simple Mail Transfer Protocol), ESMTP (Extended SMTP) protocol and so on. For ensuring the security, for example, a firewall can be further installed between sever and client.

In the present invention, the mail server system 100 includes a virus checking module 50, an account manager 60, a curing inducement module 70 and a mail transfer agent (MTA) 80. The virus checking module 50 determines whether the received electronic mail contains viruses. The account manager 60 includes data for user's authentication and identification and records the account of the infected client to memory. Further, the curing inducement module 70 informs the infected client of the infection and transmits a necessary message for curing inducement.

The mail transfer agent 80 transfers the electronic mail message transmitted from the non-infected client to receiving clients 30 and 40. All messages transmitted from the transmitting clients are subject to the checking process by the virus checking module 50 before they are delivered to the mail transfer agent 80. Thus, any messages, if infected with viruses, can not be delivered to the mail transfer agent 80 so that they can never reach receiving clients 30 and 40.

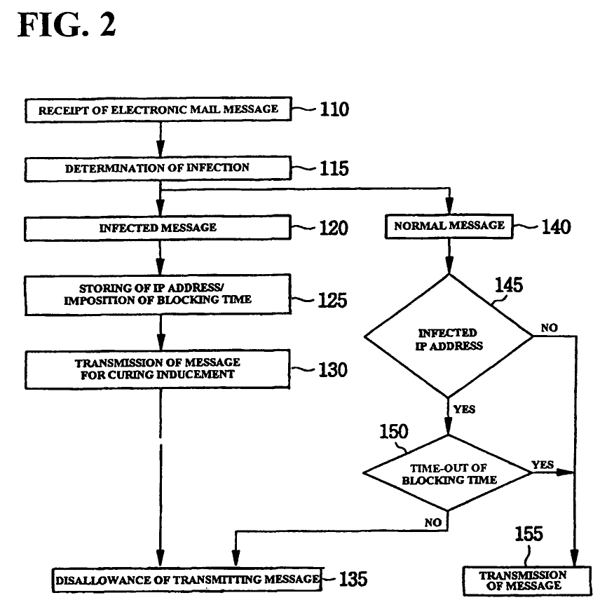

FIG. 2 is a flowchart showing a method for preventing and delaying the distribution of electronic mail viruses according to the present invention.

As shown in FIG. 2, the method according to the present invention includes receiving electronic mail messages from users (step 110); determining whether the received electronic mail messages are infected with viruses (step 115); dividing the received electronic mail messages into infected messages (step 120) and normal messages (step 140) based on the determination result; disallowing a process of only infected messages of the received electronic mail messages, storing the users' IP address to the infected IP address, and imposing the desired blocking time for the infected IP address (step 125); transmitting messages for curing inducement to the infected IP address (step 130); determining whether the message is received from the infected IP address, though the electronic mail messages transmitted from the infected IP address are normal messages (step 145); and disallowing to process normal messages until the predetermined blocking time has passed, though the electronic mail messages transmitted from the infected IP address are normal messages (step 150).

An electronic mail message may comprise an inherent message identifier, a header and an attachment file. The header includes the information related to message routing in which data such as a transmitter, a recipient, the preparation date of message are included. The electronic mail message is drawn up by transmitting client's electronic mail program, for example, Mail User Agent (MUA) such as Outlook Express and the attachment file is drawn up by an transmitting client's application program. Also, in the header, a pointer can be further included, which indicate the position of the attachment file. The attachment file can play a part as a medium in spreading viruses in the electronic mail message.

Virus check can go through the step determining whether an attachment file is a file which can be infected. For example, in the virus check, the files having .txt, .bmd, .pcx and .gif extensions are excluded so that virus check is not executed, while the files having .exe, .zip and .com extensions is subject to the virus check. The virus check is executed by decoding an attachment file. The decoding may use the conventional cryptographic algorithm and compression algorithm or a commercial virus checking program used in electronic mail systems.

In the step 115 of FIG. 2, when the transmitting client is determined to be infected with virus, the corresponding client's IP address is stored in an account manager 60. Instead of the infected client's IP address, the corresponding client's account may be stored. The infected client is informed of the virus infection and is transmitted the message for curing inducement. By the message for curing inducement, an electronic mail service provider can inform the client of the virus infection and can provide information necessary for curing the virus.

The present invention includes transmitting the message for inviting the client to cure the virus and imposing the blocking time in terms of a penalty to the infected client as well as determining whether client's electronic mail is infected with virus and informing the client of the virus infection. Until the blocking time has passed, all the messages transmitted from the infected client are denied being processed even when the transmitted message is normal message. The blocking time is determined and imposed by an electronic mail service provider. The blocking time may be determining in consideration of the required time in curing virus by the infected client's system. As mentioned in the description, it is blocked that the infected client transmits an electronic mail during the blocking time though the electronic mail is not infected, so that the time has the meaning of imposing a penalty to client.

### INDUSTRIAL APPLICABILITY

As described previously, the present invention provides a system by which the distribution of virus through an electronic mail communication can be prevented by intervention of electronic mail service providers.

Further, the present invention provides a method for preventing and delaying the distribution of electronic mail viruses, by which the infected client can cure viruses in more effective through transmitting messages for curing inducement to the users.

The system according to the present invention may prevent or delay the distribution of computer viruses through electronic mail because it prevents the circulation of computer viruses during the blocking time.

While the invention has been shown and described with reference to a certain drawings thereof, it will be understood by those skilled in the art that various changes in form and details may be made therein without departing from the spirit and scope of the invention as defined by the appended claims.

1. A system for preventing and delaying the distribution of electronic mail viruses, which connected with the plurality of transmitting clients and receiving clients comprising:
a virus checking module for determining whether viruses are contained in the electronic mail received from the transmitting clients;
an account manager for storing the account of client infected with virus; and
a curing inducement module for informing the infected clients of infection and inducing the clients to cure the viruses,
wherein the infected transmitting clients' IP address is stored as the infected IP address and a predetermined blocking time is imposed to the infected IP address, and
a process of normal messages transferred from the infected IP address is denied until the blocking time has passed.

2. The system in claim 1, wherein said curing inducement module informs the infected clients of infection and provides the infected clients with the information for curing of viruses.

3. A method for preventing and delaying the distribution of electronic mail viruses, the method comprising the steps of:
receiving electronic mail messages from users;
determining whether the received electronic mail messages are infected with viruses;
dividing the received electronic mail messages into infected messages and normal messages based on the determination result; and
disallowing a process of only infected messages of the received electronic mail messages, storing the users' IP address to the infected IP address, and transmitting messages for curing inducement to the infected users; and
imposing a predetermined blocking time for the infected IP address,
wherein the determining step includes determining whether electronic mail messages are transmitted from the infected IP address in the predetermined blocking time, and denying the normal messages to be processed until the desired blocking time has passed, even when the electronic mail messages transmitted from the infected IP address are normal messages.

4. The method of claim 3 wherein said determining step includes a process for decoding files attached to electronic mail messages.
